(19) United States
(12) Patent Application Publication
(10) Pub. No.: US 2026/0330410 A1
(43) Pub. Date: Oct. 22, 2026

(54) INFORMATION PROCESSING SYSTEM, INFORMATION PROCESSING METHOD, AND RECORDING MEDIUM IN WHICH INFORMATION PROCESSING PROGRAM IS RECORDED

(71) Applicant: SHARP KABUSHIKI KAISHA, Osaka (JP)

(72) Inventors: YU MINAKI, Osaka (JP); Satoshi Terada, Osaka (JP)

(21) Appl. No.: 19/649,335

(22) Filed: Apr. 16, 2026

(30) Foreign Application Priority Data
Apr. 18, 2025 (JP) 2025-068543

(51) Int. Cl. G06Q 10/10; G06F 3/0482; G10L 15/26

(52) U.S. Cl. CPC G06Q 10/10; G06F 3/0482; G10L 15/26

(57) ABSTRACT

A meeting assistance device includes: an acquisition processing unit that acquires a voice uttered by a user in a meeting; a speech recognition processing unit that converts the voice acquired by the acquisition processing unit into text information; a summary generation processing unit that generates a summary of an utterance content of the user based on the text information obtained by the conversion by the speech recognition processing unit; and a display processing unit that causes the summary generated by the summary generation processing unit and a specific part, in a material used in the meeting, corresponding to the summary to be displayed side by side on a display screen.

### INCORPORATION BY REFERENCE

This application is based upon and claims the benefit of priority from the corresponding Japanese Patent Application No. 2025-068543 filed on Apr. 18, 2025, the entire contents of which are incorporated herein by reference.

### BACKGROUND

The disclosure relates to a technique for displaying a summary generated by converting an uttered voice of a user into text.

With a known technique, a summary generated by converting an uttered voice of a user into text information is displayed. For example, a known meeting system divides meeting text information including text information obtained from an utterance content of a meeting participant into sections corresponding to types selected from among a plurality of types of sections, and generates summary information for each of the divided meeting text information.

When the minutes of the meeting are reviewed after the meeting ends, there is a case where it is desired to check the conversation content in the meeting and to check the materials used in the meeting. However, with the known technique, while it is possible to check the summary for each section, it is difficult to recognize which part of the material discussed corresponds to each summary.

### SUMMARY

In some embodiments, the disclosure provides a technique implemented by an information processing system, an information processing method, and a recording medium having an information processing program recorded thereon, which enable the content of a discussion corresponding to a material used in a meeting to be recognized.

An information processing system according to an aspect of the disclosure is an information processing system for managing meeting information. The information processing system includes an acquisition processing unit, a conversion processing unit, a generation processing unit, and a display processing unit. The acquisition processing unit acquires voices uttered by users in a meeting. The conversion processing unit converts the voices acquired by the acquisition processing unit into text information. The generation processing unit generates a summary of an utterance content of the users based on the text information acquired by conversion by the conversion processing unit. The display processing unit causes the summary generated by the generation processing unit and a specific part, in a material used in the meeting, corresponding to the summary to be displayed side by side on a display screen.

An information processing method according to another aspect of the disclosure is an information processing method for managing meeting information. The information processing method includes: by one or more processors, acquiring a voice uttered by a user in a meeting; converting the voice into text information; generating a summary of utterance content of the user based on the text information; and causing the summary and a specific part, in a material used in the meeting, corresponding to the summary to be displayed side by side on a display screen.

A recording medium according to another aspect of the disclosure is a recording medium recording an information processing program for managing meeting information. The information processing program is a program causing one or more processors to execute: acquiring a voice uttered by a user in a meeting; converting the voice into text information; generating a summary of utterance content of the user based on the text information; and causing the summary and a specific part, in a material used in the meeting, corresponding to the summary to be displayed side by side on a display screen.

As described herein, the disclosure relates to an information processing system, an information processing method, and a recording medium having an information processing program recorded thereon, which can be used to facilitate recognition of the content of a discussion corresponding to a material used in a meeting.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram illustrating an applied example of a meeting assistance system according to an embodiment of the disclosure.

FIG. 2 is a block diagram illustrating a configuration of the meeting assistance system according to the embodiment of the disclosure.

FIG. 3 is a table illustrating an example of equipment information utilized in the meeting assistance system according to the embodiment of the disclosure.

FIG. 4 is a table illustrating an example of utterance information utilized in the meeting assistance system according to the embodiment of the disclosure.

FIG. 5 is a table illustrating an example of summary information utilized in the meeting assistance system according to the embodiment of the disclosure.

FIG. 6 is a table illustrating an example of agenda information utilized in the meeting assistance system according to the embodiment of the disclosure.

FIG. 7A is a diagram illustrating an example of a setting screen displayed in the meeting assistance system according to the embodiment of the disclosure.

FIG. 7B is a diagram illustrating an example of the setting screen displayed in the meeting assistance system according to the embodiment of the disclosure.

FIG. 8 is a diagram illustrating an example of a meeting screen displayed in the meeting assistance system according to the embodiment of the disclosure.

FIG. 9 is a diagram illustrating an example of the meeting screen displayed in the meeting assistance system according to the embodiment of the disclosure.

FIG. 10 is a diagram illustrating an example of the meeting screen displayed in the meeting assistance system according to the embodiment of the disclosure.

FIG. 11 is a flowchart illustrating an example of a procedure of meeting assistance processing executed in the meeting assistance device according to the embodiment of the disclosure.

FIG. 12 is a flowchart illustrating an example of a procedure of the meeting assistance processing executed in the meeting assistance device according to the embodiment of the disclosure.

FIG. 13 is a table illustrating an example of meeting material information utilized in the meeting assistance system according to the embodiment of the disclosure.

FIG. 14 is a diagram illustrating an example of the meeting screen displayed in a minutes list screen displayed in the meeting assistance system according to the embodiment of the disclosure.

FIG. 15 is a diagram illustrating an example of the meeting screen displayed in a minutes screen displayed in the meeting assistance system according to the embodiment of the disclosure.

FIG. 16 is a diagram illustrating an example of the meeting screen displayed in the minutes screen displayed in the meeting assistance system according to the embodiment of the disclosure.

FIG. 17 is a diagram illustrating an example of the meeting screen displayed in the minutes screen displayed in the meeting assistance system according to the embodiment of the disclosure.

FIG. 18 is a diagram illustrating an example of the meeting screen displayed in the minutes screen displayed in the meeting assistance system according to the embodiment of the disclosure.

FIG. 19 is a flowchart illustrating an example of a procedure of summary generation processing executed in the meeting assistance device according to the embodiment of the disclosure.

FIG. 20 is a flowchart illustrating an example of a procedure of minutes display processing executed in the user terminal according to the embodiment of the disclosure.

### DETAILED DESCRIPTION

Embodiments of the disclosure will be described below with reference to the drawings. Note that the following embodiments are specific examples of the disclosure, and do not limit the technical scope of the disclosure.

An information processing system according to the disclosure can be applied to, for example, a case where a plurality of users in the same space (for example, a meeting room) have conversations (meeting) with users in other spaces by using respective audio devices each including a microphone and a speaker. Note that the information processing system can also be applied to a case where a plurality of users have conversations using respective audio devices in one space. Furthermore, the information processing system can also be applied to a case where one user in one space uses an audio device to have a conversation with a user in another space.

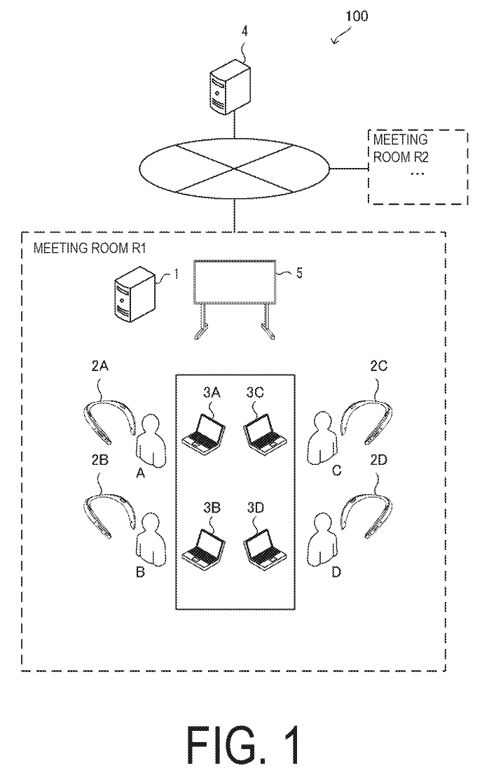

FIG. 1 is a diagram illustrating an applied example of a meeting assistance system 100 according to the embodiment. As illustrated in FIG. 1, users A to D participate in a meeting in a meeting room R1, and other users (not illustrated) participate in the meeting in a meeting room R2. The users A to D have a conversation by respectively using neckband-type audio devices 2A to 2D each of which can be worn on the neck. The users in the meeting room R2 may use audio devices 2, or may use one microphone speaker device installed in the meeting room R2. Note that, although FIG. 1 illustrates an example in which each of the users A to D uses the audio device 2, there is no limitation thereto, and some of the users may exclusively use the audio device 2. The meeting assistance system 100 is an example of an information processing system and a voice processing system of the disclosure.

Each of the audio devices 2 in the meeting room R1 is wirelessly connected (connected by Bluetooth (registered trademark)) to a meeting assistance device 1. A voice input to the microphone of each of the audio devices 2 is input to the meeting assistance device 1 and is transmitted from the meeting assistance device 1 to a meeting terminal 3. A meeting application of a meeting server 4 transmits, to the meeting room R2, the voice received by the meeting terminal 3. Thus, the voice in the meeting room R1 is output (reproduced) from the speaker of the audio device 2 (or the microphone speaker device) of the user in the meeting room R2. Similarly, the meeting application of the meeting server 4 reproduces, through the speaker of the audio device 2 of each user in the meeting room R1, the voice input to the microphone of the audio device 2 (or the microphone speaker device) in the meeting room R2.

As described above, the meeting assistance system 100 is a system that enables a plurality of users to have conversations in the same space (the meeting room R1 in FIG. 1) by individually using the audio device 2. The meeting assistance system 100 may include a display device 5 that can be used in a meeting. The meeting application displays, on the display device 5, meeting information such as camera images of the meeting participants and meeting materials, and recognition results (text information) acquired by converting voices into text by speech recognition processing.

As illustrated in FIG. 1, the meeting assistance system 100 includes the meeting assistance device 1, the audio devices 2, the meeting terminal 3, and the meeting server 4. The audio device 2 is a wireless connection-based sound instrument equipped with a microphone and a speaker. Note that the audio device 2 may include, for example, a function such as an AI speaker or a smart speaker. The meeting assistance system 100 is a system that includes a plurality of audio devices 2 and transmits and receives audio data of uttered voices of users to and from the plurality of audio devices 2. The audio devices 2 may be sound instruments of the same type or of different types. For example, the plurality of audio devices 2 may include wireless connection-based sound instruments and wired connection-based sound instruments. Further, the plurality of audio devices 2 may include neckband-type sound instruments, headset-type sound instruments, and stationary sound instruments.

The meeting assistance device 1 controls voices (input voices, output voices, and the like) to and from the audio devices 2, and executes processing of transmitting and receiving voices to and from the plurality of audio devices 2 when a meeting is started in a meeting room, for example. For example, the meeting assistance device 1 controls a plurality of audio devices 2 arranged in the same space. The meeting assistance device 1 accumulates voices acquired from the audio devices 2 as recording voices and executes processing (speech recognition processing) of converting the acquired voices into text. Note that the meeting assistance device 1 alone may constitute the information processing system and the voice processing system of the disclosure.

The information processing system of the disclosure may include a function of providing various services such as a meeting service, a caption (transcription) service through speech recognition, a translation service, and a minutes service. In the embodiment, the meeting assistance system 100 includes the meeting server 4 that provides the meeting service. The meeting server 4 provides an online meeting service of the meeting application which is general-purpose software. For example, the meeting application is installed in the meeting terminal 3. Activating the meeting terminal 3 for login enables execution of an online meeting (for example, an online meeting in the meeting room R1 and the meeting room R2) utilizing the meeting application.

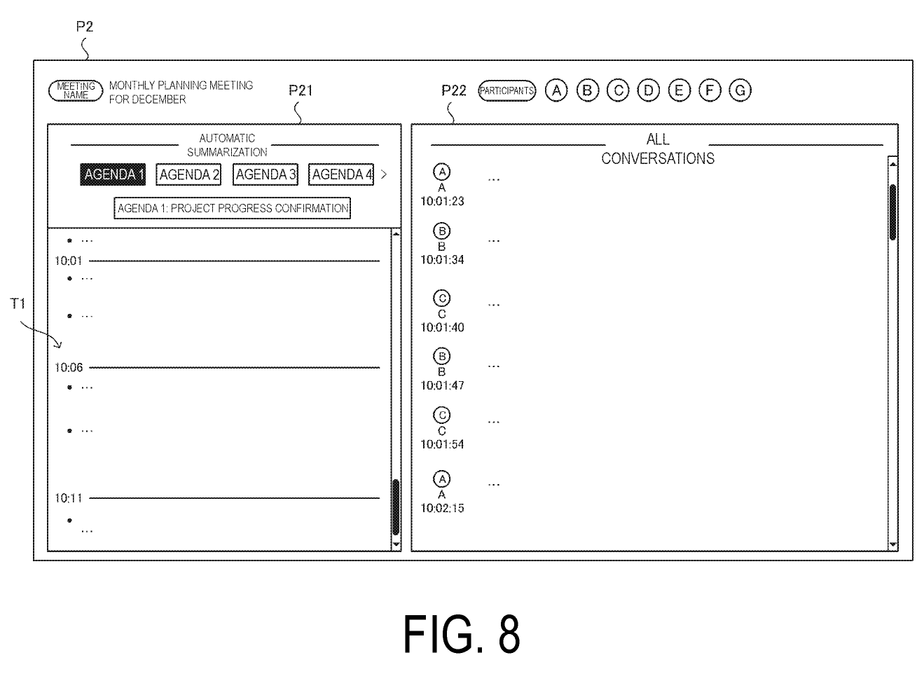

The meeting terminal 3 may be, for example, a user terminal used by a representative user (organizer) who organizes the meeting among the users who participate in the meeting. For example, a user terminal 3A of the user A who is the organizer functions as the meeting terminal 3. In this case, the users B to D can activate the meeting application on user terminals 3B to 3D and view a meeting screen P2 (FIG. 8 and the like).

### Meeting Assistance Device 1

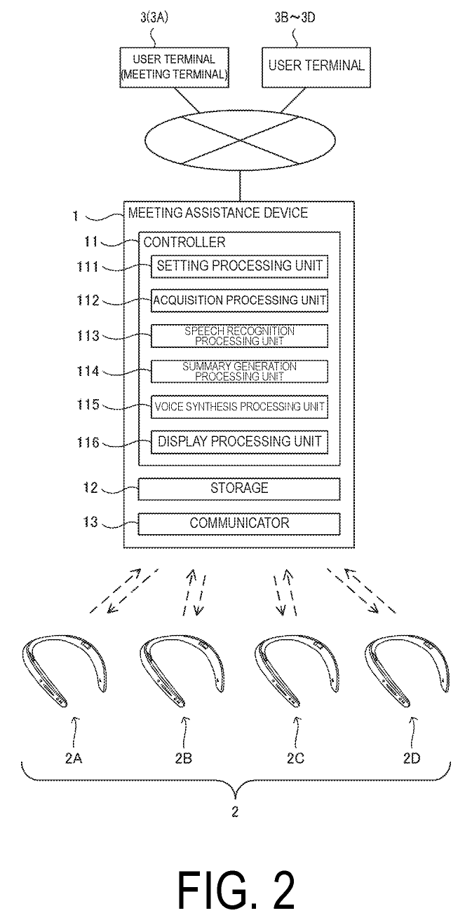

As illustrated in FIG. 2, the meeting assistance device 1 is equipment including a controller 11, a storage 12, a communicator 13, and the like. For example, the meeting assistance device 1 is connected to the plurality of audio devices 2, and includes a function of mixing or splitting voices received from the plurality of audio devices 2 or the meeting terminal 3, a speech recognition function of converting input voices into text information, and the like. In addition, the meeting assistance device 1 manages meeting information.

The communicator 13 is used to connect the meeting assistance device 1 to a communication network in a wired or wireless manner and to execute data communication with external equipment such as the audio devices 2, the meeting terminal 3, the display devices 5, and the like via the communication network in accordance with a predetermined communication protocol. For example, the communicator 13 performs pairing processing in accordance with the Bluetooth scheme to wirelessly connect to each audio device 2.

The storage 12 is a non-volatile storage such as a hard disk drive (HDD), a solid state drive (SSD), or flash memory that stores various types of information. The storage 12 stores data such as equipment information D1 related to the audio devices 2, utterance information D2 related to utterance contents, summary information D3 related to summary sentences, and agenda information D4 related to agendas.

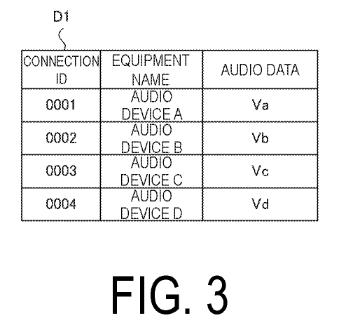

FIG. 3 illustrates an example of the equipment information D1. In the equipment information D1, information such as a connection ID, an equipment name, and audio data is registered. The connection ID is identification information (equipment information) utilized when the audio device 2 is connected, and is, for example, a Bluetooth address. The equipment name is an equipment name of the audio device 2. The audio data is data of a voice (uttered voice) acquired from the audio device 2. As described above, the audio data is stored in the equipment information D1 for each piece of equipment. Each audio data is assigned identification information of the equipment (audio device 2) and stored.

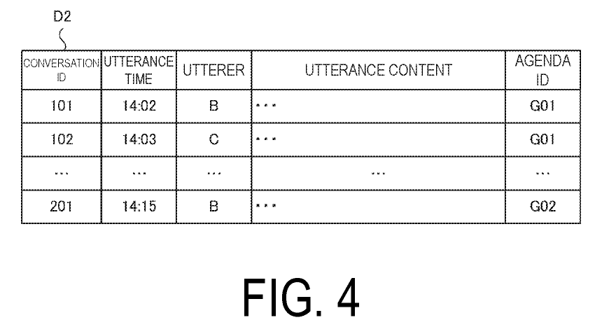

FIG. 4 illustrates an example of utterance information D2. In the utterance information D2, information such as a conversation ID, utterance time, an utterer, an utterance content, and an agenda ID is registered. The conversation ID is identification information of an utterance content of a user (utterer). The utterance time is a time at which the user issued an utterance. The utterer is the name of the user or the identification information thereof (user ID). The utterance content is character information obtained by converting a voice uttered by the user into text information. The agenda ID is identification information of an agenda of the meeting. When a meeting related to a predetermined agenda is started, the controller 11 registers each piece of information in the utterance information D2 based on an uttered voice of the user acquired from the audio device 2.

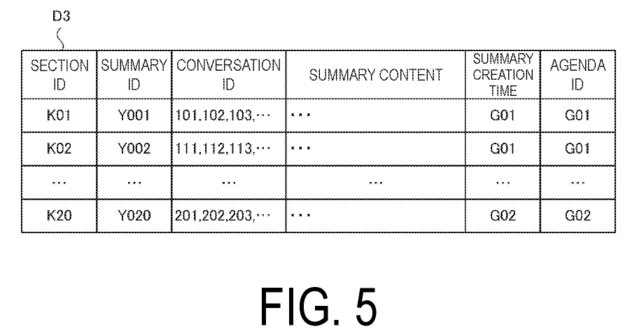

FIG. 5 illustrates an example of the summary information D3. In the summary information D3, information such as a section ID, a summary ID, a conversation ID, a summary content, a summary creation time, and an agenda ID is registered. The section ID is identification information enabling identification of sections into which the meeting is divided according to a predetermined time or a predetermined number of characters (details of the sections will be described below). The summary ID is identification information enabling identification of a summary sentence generated based on text information into which a voice has been converted (details of the summary sentence will be described below). The summary content is the content of the summary sentence, and the summary creation time is the time at which the summary sentence is generated. The controller 11 generates a summary sentence based on an uttered voice of the user during the meeting and registers each piece of information in the summary information D3.

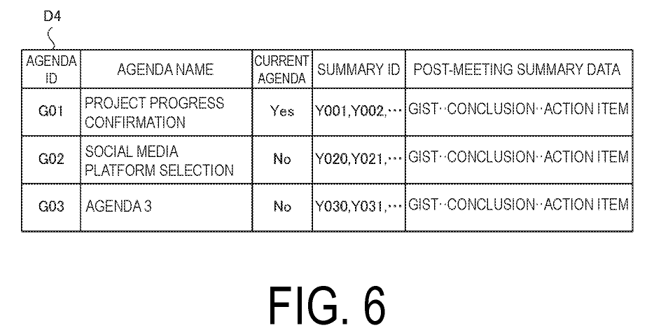

FIG. 6 illustrates an example of the agenda information D4. In the agenda information D4, information such as an agenda ID, an agenda name, a current agenda, a summary ID, and post-meeting summary data is registered. The agenda name is the name of an agenda. The current agenda is information indicating whether the current agenda is the agenda for the conversations (the meeting) currently in progress. FIG. 6 illustrates that a meeting is currently in progress for an agenda related to a "project progress confirmation". The post-meeting summary data indicates data (minutes data) generated after the end of the meeting, and includes, for example, contents related to minutes such as a gist, a conclusion, and an action item (a future policy or the like). For example, when a meeting is started for an agenda designated by a meeting organizer, the controller 11 registers each piece of information in the agenda information D4 based on the uttered voice of the user acquired from the audio device 2, and when the meeting is ended, the controller 11 registers the post-meeting summary data in the agenda information D4.

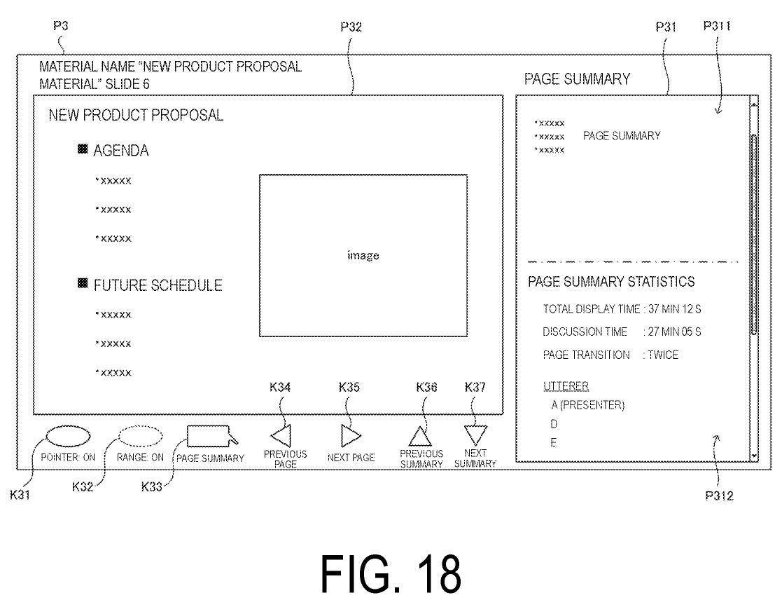

The storage 12 stores a control program such as a meeting assistance program (an example of the information processing program of the disclosure) for causing the controller 11 to execute meeting assistance processing described below (see FIG. 18). For example, the meeting assistance program may be non-transitorily recorded in a computer-readable recording medium such as a CD or a DVD, read by a reading device (not illustrated) such as a CD drive or a DVD drive included in the meeting assistance device 1, and stored in the storage 12.

The controller 11 includes control devices such as a CPU, a ROM, and a RAM. The CPU is a processor that executes various types of arithmetic processing. The ROM is a non-volatile storage that stores, in advance, control programs such as a Basic Input/Output System (BIOS) and an Operating System (OS) for causing the CPU to perform various types of arithmetic processing. The RAM is a volatile or non-volatile storage that stores various types of information and is used as a temporary storage memory (work area) for the various types of processing performed by the CPU. Then, the controller 11 controls the meeting assistance device 1 by causing the CPU to execute various types of the control programs stored in advance in the ROM or the storage 12.

Specifically, as illustrated in FIG. 2, the controller 11 includes various processing units such as a setting processing unit 111, an acquisition processing unit 112, a speech recognition processing unit 113, a summary generation processing unit 114, a voice synthesis processing unit 115, and a display processing unit 116. Note that the controller 11 functions as the various types of processing units by executing various types of processing in accordance with the control program using the CPU. Further, some or all of the processing units may be configured as electronic circuits. Note that the control programs may be programs for causing a plurality of processors to function as the processing units described above.

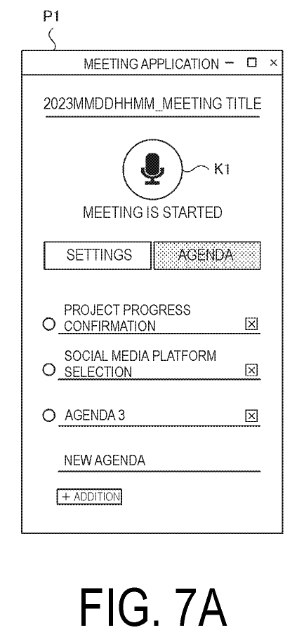

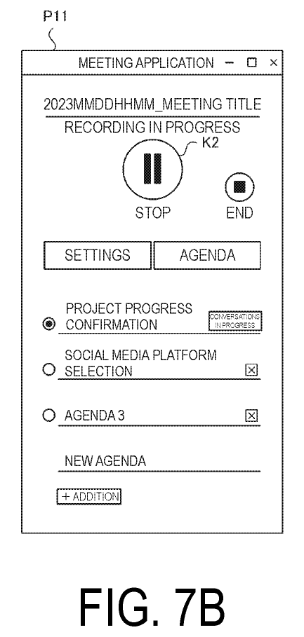

The setting processing unit 111 sets agendas of conversations (meeting). Specifically, the setting processing unit 111 receives, from a user (a meeting organizer or the like), an operation of registering a new agenda, an operation of selecting an agenda, an operation of changing the agenda for the conversations currently in progress, and the like. For example, the user A who is the organizer of the meeting activates the meeting application on the user terminal 3A (meeting terminal 3) to display a setting screen P1 (see FIG. 7A). The user A can register one or more agendas by selecting an "Agenda" field on the setting screen P1. The user A selects one agenda from a plurality of registered agendas on the setting screen P1. FIG. 7B illustrates an example of a setting screen P11 displayed after the meeting is started (during the meeting). FIG. 7B displays identification information ("conversations are in progress") indicating the agenda (for example, the "project progress confirmation") for the conversations currently in progress. In a case of changing the agenda, the user A selects another agenda on the setting screen P1. The user A can select a "Setting" field on the setting screen P1 to select users who participate in the meeting or select the audio device 2 to be used in the meeting.

Upon setting the agenda in accordance with a user operation, the setting processing unit 111 registers, in the agenda information D4 (see FIG. 6), the identification information of the agenda (agenda ID) and the agenda name. When the meeting is started, the setting processing unit 111 registers, in the agenda information D4, information ("Yes") enabling identification of the agenda of the meeting (here, the "project progress confirmation").

Note that the setting processing unit 111 may allow only a user having a predetermined authority to perform the operations of setting the agenda and starting the meeting. As another embodiment, the setting processing unit 111 may automatically set or change the agenda by analyzing the utterance contents of the users.

The acquisition processing unit 112 acquires a voice uttered by the user. Specifically, when the meeting is started and the user issues an utterance, the acquisition processing unit 112 acquires the uttered voice input to the microphone of the audio device 2 of the user. The acquisition processing unit 112 acquires time information corresponding to the utterance time of the uttered voice of the user. For example, the acquisition processing unit 112 acquires the time at which the uttered voice of the user is input to the microphone of the audio device 2 or the time at which the uttered voice is acquired.

Upon acquiring the voice from the audio device 2, the acquisition processing unit 112 stores the audio data in the equipment information D1 (see FIG. 3) in association with the identification information of the audio device 2 (connection ID, equipment name, and the like). In the example illustrated in FIG. 1, the acquisition processing unit 112 acquires, from the audio devices 2, the uttered voice of the users A to D in the meeting room R1, and stores each audio data in the equipment information D1 in association with the connection ID.

Based on the voice acquired by the acquisition processing unit 112, the speech recognition processing unit 113 executes speech recognition processing of converting the voice into text. The speech recognition processing unit 113 converts the voice into text information by using a predetermined speech recognition engine (learned model). Note that the speech recognition engine is generated by learning, for example, various audio data (teacher data). The meeting assistance device 1 is equipped with the speech recognition engine. Note that the speech recognition processing unit 113 may execute voice processing such as echo cancellation, noise cancellation, and gain adjustment on the voice acquired by the acquisition processing unit 112.

The speech recognition processing unit 113 registers the text information in the utterance information D2 (see FIG. 4) as an utterance content. The speech recognition processing unit 113 registers the identification information (conversation ID) of the utterance content, the time information (utterance time), and the identification information (name) of the utterer in association with the utterance content. The speech recognition processing unit 113 registers the identification information (agenda ID) of the agenda corresponding to the utterance content in association with the utterance content. The speech recognition processing unit 113 registers the agenda ID of the agenda set by the setting processing unit 111 in association with the utterance content. The speech recognition processing unit 113 is an example of the conversion processing unit of the disclosure.

Based on the text information to be converted by the speech recognition processing unit 113, the summary generation processing unit 114 generates a summary sentence in a short sentence format summarizing the utterance content of the user. The summary generation processing unit 114 generates summary sentences from the text information by using the predetermined summary generation engine (learned model). Note that the summary generation engine is generated by learning, for example, various conversation data and summary data (teacher data). The meeting assistance device 1 is equipped with the summary generation engine. For example, the summary generation processing unit 114 generates one summary sentence from a plurality of pieces of text information corresponding to uttered voices of one or more users.

The summary generation processing unit 114 generates summary sentences for each predetermined section. Specifically, the summary generation processing unit 114 generates one or more summary sentences at predetermined time intervals (for example, every five minutes) or for every predetermined number of characters (for example, 1500 characters) of the text information.

The summary generation processing unit 114 also registers the summary sentences in the summary information D3 (see FIG. 5) as a summary content. The summary generation processing unit 114 registers the identification information of the section (section ID), the identification information of the summary sentences (summary ID), and the identification information of the conversations corresponding to the text information (conversation ID) in association with the summary contents. The summary generation processing unit 114 registers the time when the summary sentences are generated in association with the summary contents. The summary generation processing unit 114 registers the agenda ID of the agenda set by the setting processing unit 111 in association with the summary contents. In the example illustrated in FIG. 5, conversations corresponding to a plurality of pieces of text information and having conversation IDs "101", "102", "103", ... are made in a section with a section ID "K01", and one summary (summary ID "Y001") is generated from the plurality of conversation contents. One summary sentence or a plurality of summary sentences may be generated for one section.

The summary generation processing unit 114 registers the summary ID in the agenda information D4 (see FIG. 6). Note that, in a case of generating a plurality of summary sentences for one agenda, the summary generation processing unit 114 registers a plurality of summary IDs corresponding to the summary sentences in the agenda information D4 in association with the agenda (agenda ID). The summary generation processing unit 114 is an example of a generation processing unit of the disclosure.

The voice synthesis processing unit 115 synthesizes the voices acquired by the acquisition processing unit 112. The voice synthesis processing unit 115 outputs a voice acquired by the synthesis to the meeting terminal 3 (for example, the user terminal 3A) in the meeting room R1. The meeting application of the meeting server 4 transmits, to the meeting terminal 3 in the meeting room R2, the voice received by the meeting terminal 3 in the meeting room R1.

The display processing unit 116 causes various pieces of information corresponding to the meeting application to be displayed on the display screen. Specifically, the display processing unit 116 causes the text information to be converted by the speech recognition processing unit 113 and the summary sentences corresponding to the agenda to be generated by the summary generation processing unit 114 to be displayed side by side on the meeting screen P2. For example, as illustrated in FIG. 8, in the user terminal 3, the display processing unit 116 causes the text information corresponding to the conversation in progress to be displayed in a conversation display area P22 of the meeting screen P2, and causes the summary sentences generated for each predetermined section to be displayed in a summary display area P21 of the meeting screen P2. Note that, in the conversation display area P22, the display processing unit 116 sequentially displays additional text information in real time while scrolling the screen.

The display processing unit 116 causes identification information (user names, user icons, or the like) of the users of the uttered voices corresponding to the text information and the time information (utterance time) to be displayed in the conversation display area P22 in association with the text information (utterance content).

The display processing unit 116 causes identification information enabling identification of the section (for example, summary creation time T1) to be displayed in the summary display area P21 in association with the summary sentence. For example, in a case where the summary generation processing unit 114 generates summary sentences every five minutes, the display processing unit 116 causes the time to be displayed at time intervals of five minutes in the summary display area P21 (see FIG. 8).

Note that, in the summary display area P21, each of a plurality of itemized sentences included in one section (for example, a section from 10:06 to 10:11) is a summary sentence. As another embodiment, the summary generation processing unit 114 may generate each of the itemized sentences as a main point and compile a plurality of main points into one summary sentence.

The display processing unit 116 causes a plurality of agendas to be selectively displayed in the summary display area P21 and causes the agenda selected by the users to be identifiably displayed. In a case where no agenda is selected in the summary display area P21, the display processing unit 116 causes summary sentences corresponding to the agenda for the conversations currently in progress to be displayed. As a result, the meeting screen P2 displays, side by side, the text information of the conversation related to the agenda for the conversations currently in progress and the summary sentences related to the agenda. The user can collectively check, on one meeting screen P2, the content and summary for the conversations currently in progress.

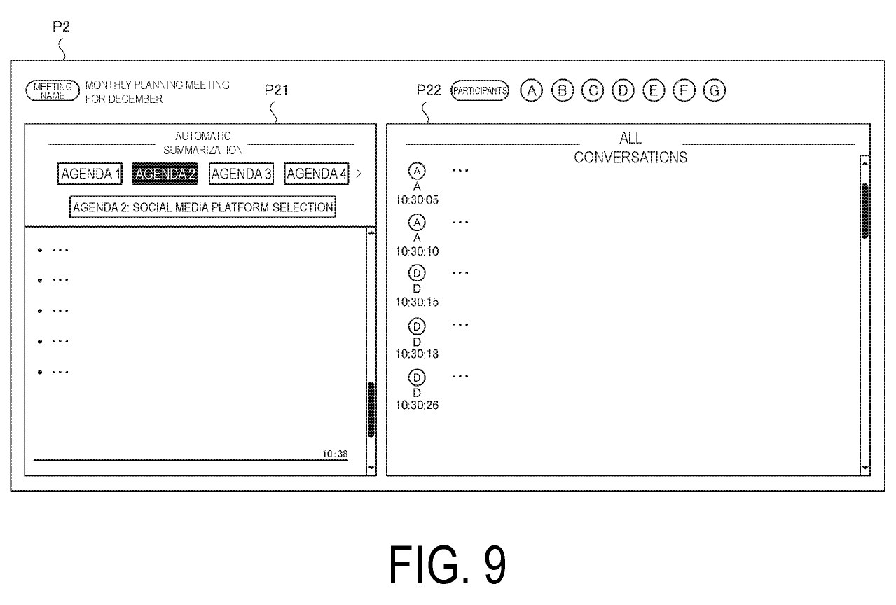

Here, when the organizer (user A) of the meeting changes the agenda from Agenda 1 ("project progress confirmation") to Agenda 2 ("social media platform selection") on the setting screen P1 (see FIG. 7A), the display processing unit 116 causes the text information related to Agenda 2 for the conversations currently in progress to be displayed in the conversation display area P22 and also causes the summary sentences corresponding to Agenda 2 to be displayed in the summary display area P21, as illustrated in FIG. 9.

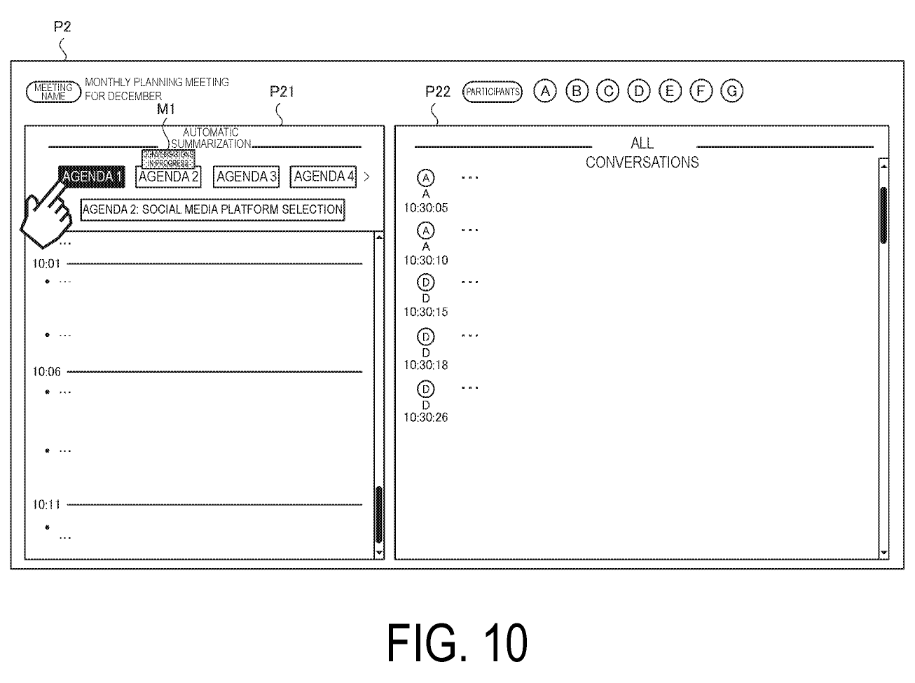

Furthermore, for example, in a case where the agenda for the conversations currently in progress is "Agenda 2" (see FIG. 9), and the users (for example, the users B to D) select "Agenda 1" in the summary display area P21, the display processing unit 116 causes summary sentences corresponding to Agenda 1 to be displayed in the summary display area P21 as illustrated in FIG. 10. As a result, the meeting screen P2 displays the text information related to Agenda 2 for the conversations currently in progress and the summary sentences related to Agenda 1 selected by the users. In this case, the display processing unit 116 causes an identification mark M1 enabling identification of Agenda 2 for the conversations currently in progress to be displayed in the summary display area P21 in association with Agenda 2 to allow the user to recognize Agenda 2 for the conversations currently in progress. As another embodiment, the display processing unit 116 may cause an icon of Agenda 2 for the conversations currently in progress and an icon of Agenda 1 selected by the users to be displayed in the summary display area P21 in different display modes.

As described above, in a case where the user desires to check the contents of the previous "Agenda 1" after the agenda of the meeting is switched from "Agenda 1" (see FIG. 8) to "Agenda 2" (see FIG. 9), the user can check the summary sentences for Agenda 1 by selecting "Agenda 1" in the summary display area P21 (see FIG. 10) while conversations are in progress for Agenda 2. On one meeting screen P2, the user can collectively check the summary sentences for the agenda in the past and the conversation content for the conversations currently in progress.

### Meeting Assistance Processing

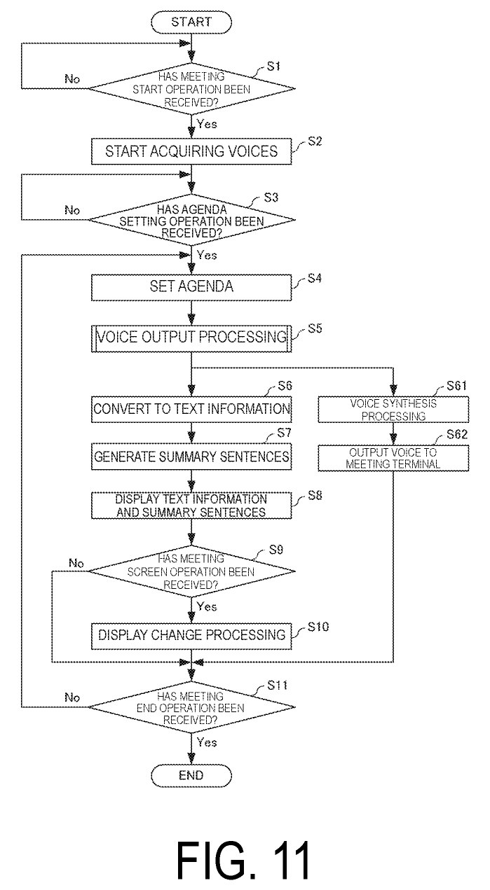

FIG. 11 illustrates an example of a procedure of meeting assistance processing executed by the controller 11 of the meeting assistance device 1.

Note that the disclosure can be regarded as a meeting assistance method (information processing method and voice processing method of the disclosure) of executing one or more steps included in the meeting assistance processing. One or more steps included in the meeting assistance processing described herein may be omitted as appropriate. Each of the steps in the meeting assistance processing may be executed in a different order to the extent that similar effects are produced. Furthermore, here, a case in which the controller 11 executes each of the steps in the meeting assistance processing will be described as an example, but in another embodiment, one or more processors may execute each of the steps in the meeting assistance processing in a distributed manner.

Here, as illustrated in FIG. 1, a case where a meeting is held using the plurality of audio devices 2 arranged in the meeting room R1 will be described as an example. Agendas are assumed to be registered in advance before the meeting is started. Note that the user can also register an agenda during the meeting after the start of the meeting.

### Step S1

First, in step S1, the controller 11 determines whether an operation of starting the meeting has been received. For example, the user A who is the organizer of the meeting activates the meeting application on the meeting terminal 3 (the user terminal 3A) and presses a start button K1 on the setting screen P1 (see FIG. 7A). In a case of receiving an operation of pressing the start button K1, the controller 11 determines that the meeting start operation has been received. Upon determining that the meeting start operation has been received (S1: Yes), the controller 11 transitions the processing to step S2. The controller 11 waits until the meeting start operation is received (S1: No).

### Step S2

Next, in step S2, the controller 11 starts processing of acquiring, from the audio device 2, a voice uttered by a user. For example, when the meeting is started and a voice uttered by the user B is input to the microphone of an audio device 2B, the controller 11 acquires the voice from the audio device 2B. In a case where the voice of the user B is also input to the microphone of the audio device 2 of another user, the controller 11 also acquires the voice from this audio device 2.

### Step S3

Next, in step S3, the controller 11 determines whether an operation of setting an agenda of the meeting is received. For example, when the user A selects an agenda of the meeting on the setting screen P1, the controller 11 receives the selection operation. Upon receiving the selection operation (S3: Yes), the controller 11 transitions the processing to step S4. The controller 11 waits until the selection operation is received from the user (S3: No).

### Step S4

In step S4, the controller 11 sets the agenda selected by the user. Upon setting the agenda, the controller 11 registers information regarding the agenda (agenda ID, agenda name, and the like) in the agenda information D4 (see FIG. 6).

### Step S5

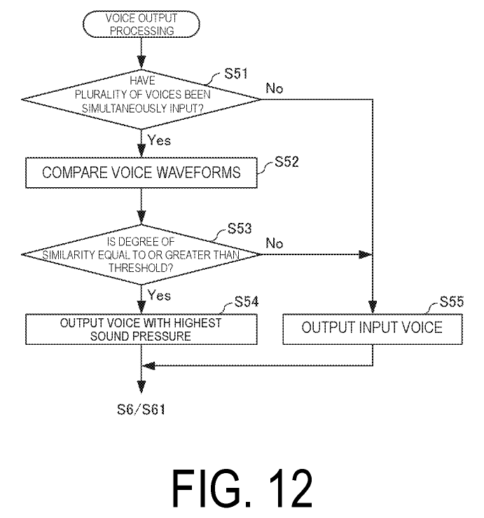

Next, in step S5, the controller 11 executes voice output processing. The controller 11 outputs a voice acquired from one audio device 2 or a plurality of voices acquired substantially simultaneously from a plurality of audio devices 2 to the speech recognition processing unit and the voice synthesis processing unit according to a predetermined condition. FIG. 12 illustrates a specific example of the voice output processing.

### Step S51

In step S51 of FIG. 12, the controller 11 determines whether a plurality of voices have been substantially simultaneously input from the plurality of respective audio devices 2. Upon determining that a plurality of voices have been substantially simultaneously input (S51: Yes), the controller 11 transitions the processing to step S52. On the other hand, upon determining that a plurality of voices have not been substantially simultaneously input (S51: No), the controller 11 transitions the processing to step S55.

### Step S52, S53

In step S52, the controller 11 compares the waveforms of the plurality of voices with one another. Next, in step S53, the controller 11 determines whether the degree of similarity among the plurality of voices is equal to or greater than a threshold. Specifically, the controller 11 compares the waveforms of the voices with one another to calculate the degree of similarity among the voices, and determines whether the calculated degree of similarity is equal to or greater than the threshold. Upon determining that the degree of similarity is equal to or greater than the threshold (S53: Yes), the controller 11 transitions the processing to step S54. On the other hand, upon determining that the degree of similarity is less than the threshold (S53: No), the controller 11 transitions the processing to step S55.

### Step S54

In step S54, the controller 11 outputs, to the speech recognition processing unit and the voice synthesis processing unit, the voice having the highest sound pressure from among the plurality of similar voices. As another embodiment, the controller 11 may output, to the speech recognition processing unit and the voice synthesis processing unit, the voice having the shortest delay time (the earliest arrival time) from among the plurality of similar voices.

### Step S55

On the other hand, in step S55, the controller 11 outputs the input one or more voices to the speech recognition processing unit and the voice synthesis processing unit. For example, in a case where the plurality of voices have not been substantially simultaneously received (S51: No), the controller 11 outputs each of the voices to the speech recognition processing unit and the voice synthesis processing unit in the order of input. For example, in a case where the plurality of voices are not similar (S53: No), the controller 11 outputs each of the voices to the speech recognition processing unit and the voice synthesis processing unit.

After the voice output processing (S5), the controller 11 transitions the processing to steps S6 and S61 (see FIG. 11).

### Step S6

In step S6, the controller 11 executes the speech recognition processing. Specifically, the controller 11 uses a predetermined speech recognition engine (learned model) to acquire the voice output in step S5 and to convert the voice into text information. The controller 11 registers the text information (utterance content) in the utterance information D2 in association with the time information (utterance time), the utterer, and the agenda (agenda ID) (see FIG. 4).

### Step S7

Next, in step S7, the controller 11 executes processing of generating summary sentences. Specifically, the controller 11 generates summary sentences from the text information using a predetermined summary generation engine (learned model). The controller 11 generates summary sentences for each predetermined section. Specifically, the controller 11 generates summary sentences per predetermined time (for example, every five minutes) or for every predetermined number of characters (for example, 1500 characters) of the text information.

The controller 11 registers each generated summary sentence (summary content) in the summary information D3 in association with the section (section ID), the summary ID, the conversation (conversation ID) corresponding to the text information, and the agenda ID (see FIG. 5). The controller 11 registers the summary ID in the agenda information D4 (see FIG. 6).

### Step S8

Next, in step S8, the controller 11 causes the text information and the summary sentences to be displayed on the display screen. Specifically, in the meeting screen P2 (see FIG. 8), the controller 11 causes the text information for the conversations in progress to be displayed in the conversation display area P22, while causing the summary sentences generated for each predetermined section to be displayed in the summary display area P21. In the conversation display area P22, the controller 11 sequentially displays additional text information in real time while scrolling the screen. In the conversation display area P22, the controller 11 causes the identification information (user names, user icons) of the users of the uttered voices corresponding to the text information and the time information (utterance time) to be displayed in association with the text information.

### Step S9

Next, in step S9, on the meeting screen P2, the controller 11 determines whether a user operation has been received. Upon determining, on the meeting screen P2, that a user operation has been received (S9: Yes), the controller 11 transitions the processing to step S10. On the other hand, upon determining, on the meeting screen P2, that no user operation has been received (S9: No), the controller 11 transitions the processing to step S11. For example, on the meeting screen P2, the user can perform an operation of selecting an agenda, an operation of selecting a summary sentence, an operation of selecting text information (conversation content), and the like.

### Step S10

In step S10, the controller 11 executes display change processing according to the user operation. For example, in a case where the agenda for the conversations currently in progress is "Agenda 2" (see FIG. 9), and the user selects "Agenda 1" in the summary display area P21, the controller 11 causes the summary sentences corresponding to agenda 1 to be displayed in the summary display area P21 as illustrated in FIG. 10. In this case, in the summary display area P21, the controller 11 causes the identification mark M1 enabling identification of "Agenda 2" for the conversations currently in progress to be displayed in the vicinity of "Agenda 2".

After step S10, the controller 11 transitions the processing to step S11.

### Step S61

On the other hand, in step S61, the controller 11 executes the voice synthesis processing. Specifically, in a case where a plurality of similar voices are substantially simultaneously input, the controller 11 executes the synthesis processing on the voice with the highest sound pressure. In a case where a plurality of dissimilar voices are substantially simultaneously input, the controller 11 executes processing of synthesizing the plurality of voices into one voice.

### Step S62

Next, in step S62, the controller 11 outputs, to the meeting terminal 3 (for example, the user terminal 3A), the voice obtained by the synthesis. The meeting application of the meeting server 4 transmits, to the meeting terminal 3 in the meeting room R2, the voice received by the meeting terminal 3 in the meeting room R1. After step S62, the controller 11 transitions the processing to step S11.

### Step S11

In step S11, the controller 11 determines whether an operation of ending the meeting has been received. For example, the user A ends the meeting application in a case of ending the meeting. In a case of having received the operation of ending the meeting application, the controller 11 determines that the meeting end operation has been received. Upon determining that the meeting end operation has been received (S11: Yes), the controller 11 ends the meeting assistance processing. On the other hand, in a case of not having received the meeting end operation (S11: No), the controller 11 returns the processing to step S1.

After returning to step S1, for example, when the user A performs an operation of changing the agenda, the controller 11 sets a new agenda (S4) and starts conversations for the agenda. For example, the user presses a stop button K2 on the setting screen P11 (see FIG. 7B) and selects another agenda on the setting screen P1 (see FIG. 7A). When the selected agenda is set (S4), the controller 11 executes the above-described processing (S5 to S10) on the voices of the utterance contents related to the agenda. The controller 11 repeatedly executes the above-described processing in accordance with the agenda until the meeting ends.

Here, when the user sets, for example, "Agenda 1 " and changes to "Agenda 2" after conversations for Agenda 1 are made, summary sentences are generated respectively for the Agenda 1 and Agenda 2. In a case where the user returns to "Agenda 1" and conversations are made, a summary sentence for the previous conversations related to the Agenda 1 and a summary sentence for the subsequent conversation related to Agenda 1 are generated. As another embodiment, the controller 11 may re-generate summary sentences in which the summary sentences for the previous conversations and the summary sentences for the subsequent conversations are compiled for "Agenda 1". As described above, even in a case where the agenda is changed to a new one or returned to the original agenda, an appropriate summary sentence can be generated for each agenda. On the meeting screen P2, the user can check the summary sentence and the conversation content for the previous conversation and the summary sentence and the conversation content for the subsequent conversation for the same agenda.

As another embodiment, the controller 11 may generate minutes of the meeting when the meeting ends. For example, when a meeting is held for a plurality of agendas, the controller 11 generates, for each agenda, minutes including compiled summary sentences. The controller 11 may generate a gist, a conclusion, an action item, and the like for one agenda based on the plurality of summary sentences of the agenda, and compiles the gist, the conclusion, the action item, and the like into minutes. The controller 11 may store the minutes in the storage 12 or may upload the minutes to a shared folder of a data server (not illustrated). Each user may be able to access the shared folder and view the minutes on the user terminal 3.

As described above, the meeting assistance system 100 according to the disclosure acquires voices uttered by users, converts the voices into text information, generates summary sentences based on the text information, and displays the text information and the summary sentences side by side on a display screen (meeting screen P2). As a result, the utterance contents corresponding to the sources of the summary sentences can be checked together with the summary results, thus enabling improvement of the convenience of the function of displaying the summary based on the utterance content.

As another embodiment, the meeting assistance system 100 sets agendas of conversations, acquires voices uttered by users, converts the voices into text information, generates summary sentences for each agenda based on the text information, and displays, side by side on a display screen, the text information and the summary sentences corresponding to the agenda (meeting screen P2). This allows the summary sentences for each agenda to be recognized and also allows the utterance contents corresponding to the sources of the summary sentences to be checked together with the summary results, thus enabling the convenience to be further improved.

### Management of meeting Material

In a meeting, materials corresponding to an agenda are often used. For example, a presenter of a meeting presents materials displayed on the display device 5 (see FIG. 1), or participants of a meeting discuss while viewing the materials. In such a meeting, when the minutes of the meeting are reviewed after the meeting ends, there is a case where it is desired to check the content of the conversation (discussion) in the meeting and to check the materials used in the meeting. However, with the known technique, while it is possible to check the summary for each section, it is difficult to recognize which part of the material discussed corresponds to each summary. Therefore, the meeting assistance system 100 according to the embodiment further includes a configuration enabling recognition of the content of the discussion corresponding to the material used in the meeting. Hereinafter, a specific example of the configuration will be described.

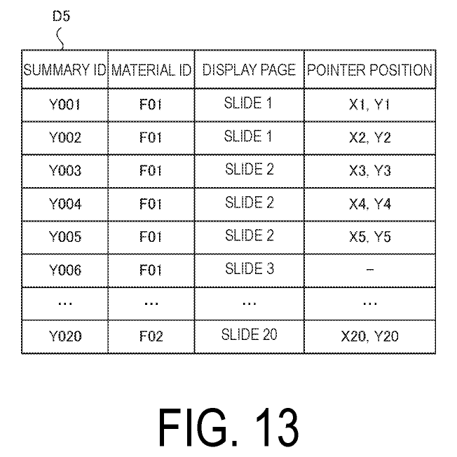

The storage 12 stores meeting material information D5 related to a material used in a meeting. FIG. 13 illustrates an example of the meeting material information D5. In the meeting material information D5, information such as a summary ID, a material ID, a display page, and a pointer position is registered. The summary ID is identification information enabling identification of a summary sentence generated based on text information into which the uttered voice has been converted, and is the same as the summary ID registered in the summary information D3 (see FIG. 5).

The material ID is identification information enabling identification of a material (file) used in a meeting, and is, for example, a file name. The data of the material corresponding to the material ID is registered in advance in the storage 12. In another embodiment, the data of the material may be stored in an external data server. The display page is a page of the material, and is identification information of a page displayed on the display device 5 or the user terminal 3 when the voice used for generating the summary sentence is uttered. For example, "Slide 1" with a material ID "F01" indicates a page that was displayed on the display device 5 or the user terminal 3 when the voice used for generating a summary sentence with a summary ID "Y001" and the voice used for generating the summary sentence with a summary ID "Y002" were uttered. In addition, "Slide 2" with a material ID "F01" indicates a page displayed on the display device 5 or the user terminal 3 when the voice used to generate the summary sentence with a summary ID "Y003", the voice used to generate the summary sentence of with a summary ID "Y004", and the voice used to generate the summary sentence with a summary ID "Y005" are uttered. Data of a page (screen) corresponding to the display page is registered in the storage 12. In another embodiment, the data of the page may be stored in an external data server. The data of the page may be a still image (for example, a captured image) or a moving image.

The pointer position is information indicating a position designated by the user using the pointer or a position to which the pointer is moved, in the material displayed on the display device 5 or the user terminal 3. For example, the pointer position represents a position and a movement trajectory designated using an indication tool such as a mouse, a touch pen, or a finger of a user, in a page being displayed. The pointer position is not limited to one set of coordinates in the display area, and may be a movement range including a movement trajectory. For example, "X1,Y1" indicates the position and the movement trajectory of the pointer while the user is uttering the voice used for generating the summary sentence with the summary ID "Y001" in a state where "Slide 1" with the material ID "F01" is displayed. For example, "X2,Y2" indicates the position and the movement trajectory of the pointer while the user is uttering the voice used for generating the summary sentence with the summary ID "Y002" in a state where "Slide 1" with the material ID "F01" is displayed. Note that, when the user does not use the pointer during the speech, the pointer position is not registered (see summary ID "Y006" in FIG. 13).

In this manner, the controller 11 registers the page of the material displayed during the speech in association with the summary sentence corresponding to the speech of the user during the meeting. The controller 11 registers the page in association with each summary sentence.

Specifically, the controller 11 stores text information obtained by converting the uttered voice into text during the meeting in the utterance information D2 (see FIG. 4), and stores the page being displayed on the display device 5 or the user terminal 3 in the storage 12. When a predetermined operation (an indication operation using a pointer, a page turning operation, or the like) on a displayed page (display screen) of the material is received, the controller 11 stores the page being displayed and the position of the pointer in the storage 12. When the meeting ends, the controller 11 generates a summary sentence based on the text information stored in the utterance information D2, stores the summary sentence in the summary information D3, and stores identification information (summary ID) of the summary and a page corresponding to the summary sentence in the meeting material information D5 (see FIG. 13) in association with each other. In this way, the controller 11 creates and stores the minutes of the meeting in which the summary sentence and the corresponding page of the material are associated with each other. Note that time information (such as time of designation and movement of a pointer) of an operation on the page may be registered in the meeting material information D5.

When a request to view the minutes of the meeting is received from the user after the meeting ends, the controller 11 causes the minutes including the summary sentence of the meeting and the corresponding page of the material to be displayed on the user terminal 3. Hereinafter, a specific configuration of the display processing by the display processing unit 116 will be described.

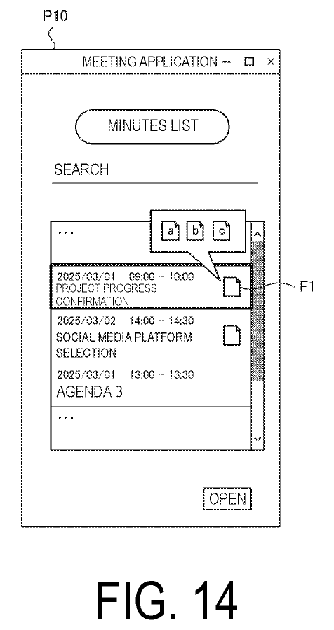

FIG. 14 is a screen (minutes list screen P10) for displaying a list of minutes of a meeting. For example, the user activates the meeting application on the user terminal 3 to display the minutes list screen P10. The user can select a target meeting the minutes of which the user desires to view on the minutes list screen P10. When a plurality of materials (files) are used in the meeting, an icon (material icon F1) for selecting a material (file) desired to be viewed from among the plurality of materials is displayed on the minutes list screen P10. The user can select the material icon F1 to select a desired material from a plurality of materials (materials a to c in FIG. 14).

Specifically, the display processing unit 116 causes, for each meeting, the agenda, the date and time when the meeting was held, the material icon F1 of the material used in the meeting, and the like to be displayed on the minutes list screen P10 (see FIG. 14) based on the agenda information D4 (see FIG. 6) and the meeting material information D5 (see FIG. 13). The minutes list screen P10 in FIG. 14 illustrates a state in which the meeting of the agenda "project progress confirmation" is selected.

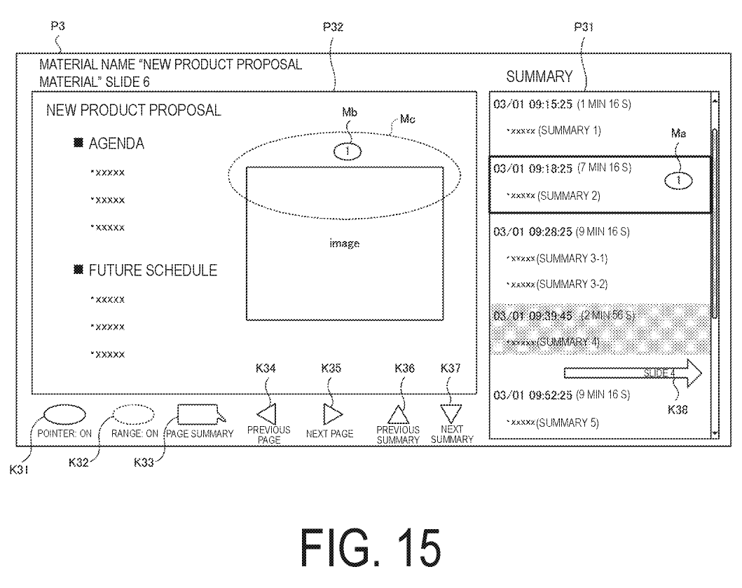

When the user selects a specific meeting on the minutes list screen P10, the display processing unit 116 causes a summary sentence of the selected meeting and a page corresponding to the summary sentence in the material used in the meeting to be displayed side by side on the display screen (minutes screen P3). FIG. 15 illustrates an example of the minutes screen P3. The display processing unit 116 causes a summary sentence to be displayed in a summary display area P31 of the minutes screen P3, and causes the corresponding page of the material to be displayed in a material display area P32 of the minutes screen P3. When a plurality of materials are registered for the meeting, the display processing unit 116 causes the page of the material selected from the plurality of materials (materials a to c in FIG. 14) by the user selecting the material icon F1 and the summary sentence to be displayed side by side.

For example, the display processing unit 116 causes a plurality of summary sentences arranged in chronological order from the start time of the meeting to be displayed in the summary display area P31 for the meeting with the agenda "project progress confirmation". The display processing unit 116 causes each summary sentence to be displayed in association with the utterance start time of the voice used to generate the summary sentence and the utterance time (total utterance time) of the voice used to generate the summary sentence. For example, in the minutes screen P3 illustrated in FIG. 15, "03/01 09:15:25" represents the utterance start time of the voice used for generating "Summary 1", and "1 min 16 s" represents the total utterance time of the voice used for generating "Summary 1". That is, "Summary 1" is generated based on the utterance content of one or more users who have discussed (spoken) during a section of "1 min 16 s" from "03/01 09:15:25".

The display processing unit 116 causes the material "new product proposal material" used in the meeting to be displayed in the material display area P32 for the meeting with the agenda "project progress confirmation". Specifically, the display processing unit 116 causes a page corresponding to the summary sentence displayed in the summary display area P31 (in FIG. 15, the page of "Slide 6") to be displayed. The display processing unit 116 causes the page selected by the user to be displayed in the material display area P32. For example, when the user presses a page turn button ("previous page" button K34 or "next page" button K35) on the minutes screen P3, the display processing unit 116 switches the page. When the page is switched, the display processing unit 116 causes the summary sentence corresponding to the switched page to be displayed in the summary display area P31.

When the summary sentence displayed in the summary display area P31 corresponds to a page different from the page being displayed in the material display area P32, the display processing unit 116 causes the summary sentence to be identifiably displayed. For example, in the example illustrated in FIG. 15, "Summary 4" is a page corresponding to "Slide 4" different from "Slide 6" being displayed in the material display area P32. In this case, the display processing unit 116 causes the information related to "Summary 4" to be identifiably displayed, such as being displayed in a different font. The display processing unit 116 causes a transition button K38 for transitioning to "Slide 4" to be displayed. When the user presses the transition button K38, the display processing unit 116 causes the page of "Slide 4" in the material display area P32 to be displayed. As another embodiment, when the user presses a summary sentence switching button ("previous summary" button K36 or "next summary" button K37) to select "Summary 4", the display processing unit 116 may cause the page of "Slide 4" to be displayed in the material display area P32.

In this manner, the display processing unit 116 causes the summary sentence generated by the summary generation processing unit 114 and the page corresponding to the summary sentence in the material used in the meeting to be displayed side by side on the display screen (the minutes screen P3). The display processing unit 116 causes the summary sentence in the summary display area P31 and the page in the material display area P32 in conjunction with each other to be displayed on the minutes screen P3. The display processing unit 116 may cause a plurality of pages of a material selected by the user from the plurality of materials to be displayed on the minutes list screen P10 (see FIG. 14) on a preview screen (not illustrated), and cause the page selected by the user and the summary sentence to be displayed side by side on the preview screen. In this manner, the display processing unit 116 may implement transition from the screen for selecting the material to the minutes screen P3 (see FIG. 15) in response to a user operation. As another embodiment, the display processing unit 116 may implement transition from the meeting screen P2 (see FIG. 10) to the minutes screen P3 (see FIG. 15) in response to a user operation.

The display processing unit 116 causes identification information enabling identification of the summary sentence in the summary display area P31 and a portion corresponding to the summary sentence in the page of the material display area P32 to be displayed on the minutes screen P3. The display processing unit 116 causes the identification image to be displayed at a portion designated by the user on the page of the material during the meeting.

For example, as illustrated in FIG. 15, when the user selects the summary sentence "Summary 2", the display processing unit 116 causes a movement range image Mc indicating a range of movement of the pointer during the utterance of the voice used to generate "Summary 2", to be displayed on the page ("Slide 6") of the material display area P32 in an overlapping manner. The display processing unit 116 causes an identification image Ma ("1") to be displayed in "Summary 2" of the summary display area P31, and causes an identification image Mb ("1") that is the same as the identification image Ma in association with the movement range image Mc to be displayed in the page of the material display area P32. Accordingly, the user can recognize the portion in the material designated using the pointer while the utterance related to "Summary 2" is in progress. The identification image is, for example, an icon image such as a character, a symbol, or a figure.

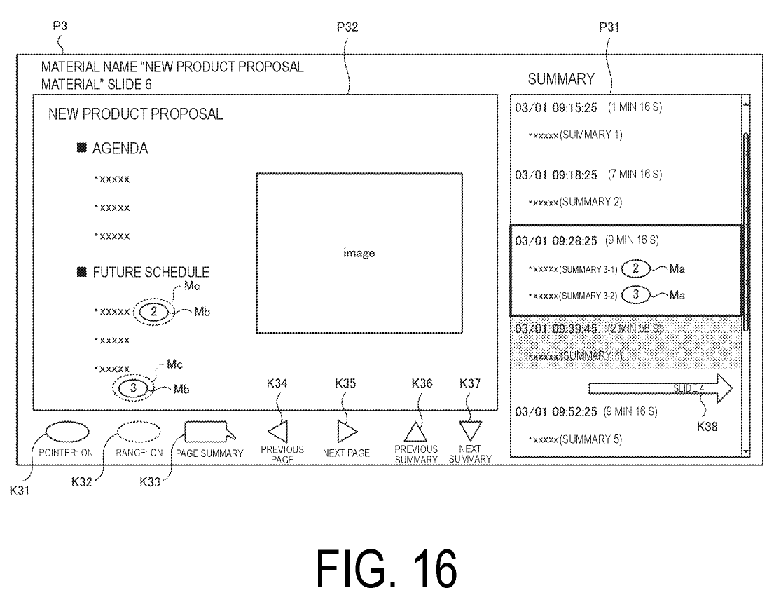

For example, as illustrated in FIG. 16, when the user selects the summary sentence "Summary 3", the display processing unit 116 causes the movement range image Mc indicating a range of movement of the pointer during the utterance of the voice used to generate "Summary 3", to be displayed on "Slide 6" of the material display area P32 in an overlapping manner, and causes the identification image Ma ("1") to be displayed on "Summary 3" of the summary display area P31. In addition, in a case where two summaries "Summary 3-1" and "Summary 3-2" are generated, the display processing unit 116 causes identification images Mb ("2" and "3") that are the same, to be displayed in association with the movement range images Mc so that the movement range images Mc corresponding to the respective summaries can be identified. The display processing unit 116 causes images (here, "2" and "3") different from the identification images (the identification image "1" for "Summary 1" and the movement range image Mc illustrated in FIG. 15) attached to another summary and movement range image Mc to be displayed.

As described above, the display processing unit 116 causes a plurality of summary sentences to be displayed in the summary display area P31 of the minutes screen P3, and when the user selects a specific summary sentence from the plurality of summary sentences, the display processing unit 116 causes the summary sentence and a portion in the page displayed in the material display area P32 corresponding to the summary sentence to be identifiably displayed. The display processing unit 116 causes the same identification images respectively to be displayed in association with the selected summary sentence and the portion. For example, when the user selects a specific summary in the summary display area P31, the display processing unit 116 causes the position (movement range) of the pointer in the page of the material corresponding to the summary to be identifiably displayed.

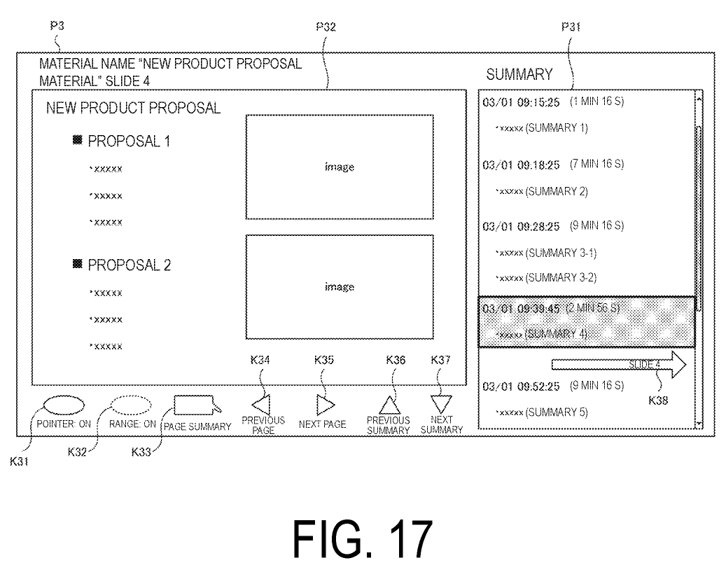

In the summary display area P31, when the user selects a summary sentence (here, "Summary 4") corresponding to a page different from the page being displayed in the material display area P32, the display processing unit 116 causes the page of Slide 4 to be displayed in the material display area P32 as illustrated in FIG. 17. As another embodiment, the display processing unit 116 may cause the page of Slide 4 to be displayed in the material display area P32 when the user presses the transition button K38. In this manner, in a case where a plurality of first summary sentences displayed in the summary display area P31 include a second summary sentence corresponding to the second page different from the first page being displayed in the material display area P32, when the user selects the second summary sentence, the display processing unit 116 causes the second page to be displayed in the material display area P32. This allows the user to immediately cause the page corresponding to the summary sentence to be displayed without operating the page turn buttons (the "previous page" button K34 and the "next page" button K35). As illustrated in FIG. 15 and the like, the display processing unit 116 may cause the first summary sentence and the second summary sentence to be displayed in different display modes in the summary display area P31.

The display processing unit 116 causes a switching button ("pointer" button K31) for switching between display and non-display of an identification image Mb corresponding to the position of the pointer and an identification image Ma for the summary corresponding thereto to be displayed on the minutes screen P3. The user can press the "pointer" button K31 to switch between display and non-display of the identification images Ma and Mb.

The display processing unit 116 causes a switching button ("range" button K32) for switching between display and non-display of the movement range image Mc to be displayed on the minutes screen P3. The user can press the "range" button K32 to switch between display and non-display of the movement range image Mc.

The display processing unit 116 causes a switching button ("page summary" button K33) for switching between display and non-display of a summary sentence (page summary) of the page being displayed in the material display area P32, to be displayed on the minutes screen P3. When the user presses the "page summary" button K33, the display processing unit 116 receives a display request for a page summary, and generates one or more summary sentences based on the plurality of summary sentences (see FIG. 13) associated with the page being displayed in the material display area P32 and causes the summary sentences to be displayed in a first area P311 of the summary display area P31, as illustrated in FIG. 18. The display processing unit 116 causes information on the page summary ("page summary statistics") to be displayed in a second area P312 of the summary display area P31. For example, the display processing unit 116 causes information such as the total time ("total display time") for which the page being displayed in the material display area P32 has been displayed during the meeting, the utterance time ("discussion time") of the voice used to generate the page summary corresponding to the page, the number of times of transition from the page to another page during the meeting ("page transition"), and the name of the user who has spoken while the page is being displayed during the meeting to be displayed in the second area P312. Thus, the user can intuitively recognize various types of information on the page. When the user presses the "page summary" button K33 again, the display processing unit 116 causes the screen illustrated in FIG. 15 to be displayed. The page summary is an example of a specific summary of the disclosure.

### Summary Generation Processing

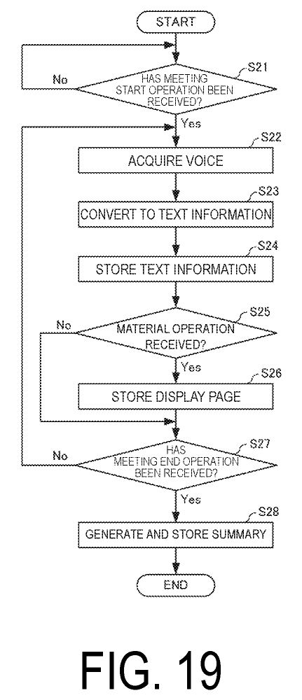

FIG. 19 illustrates an example of a procedure of summary generation processing. The summary generation processing is included in the meeting assistance processing (see FIG. 11).

### Step S21

In step S21, the controller 11 determines whether an operation of starting a meeting has been received. For example, the user A who is the organizer of the meeting activates the meeting application on the meeting terminal 3 (the user terminal 3A) and presses the start button K1 on the setting screen P1 (see FIG. 7A). In a case of receiving an operation of pressing the start button K1, the controller 11 determines that the meeting start operation has been received. Upon determining that the meeting start operation has been received (S21: Yes), the controller 11 transitions the processing to step S22. The controller 11 waits until the meeting start operation is received (S21: No).

### Step S22

Next, in step S22, the controller 11 acquires from the audio device 2, a voice uttered by a user. For example, when the meeting is started and a voice uttered by the user B is input to the microphone of the audio device 2B, the controller 11 acquires the voice from the audio device 2B. In a case where the voice of the user B is also input to the microphone of the audio device 2 of another user, the controller 11 also acquires the voice from this audio device 2.

### Step S23

Next, in step S23, the controller 11 converts the acquired voice into text information. For example, the controller 11 executes speech recognition processing using a predetermined speech recognition engine (learned model).

### Step S24

Next, in step S24, the controller 11 registers the text information (utterance content) in the utterance information D2 in association with the time information (utterance time), the utterer, and the agenda (agenda ID) (see FIG. 4).

### Step S25

Next, in step S25, the controller 11 determines whether a predetermined operation has been received from the user for the material being displayed on the display device 5 (see FIG. 1). For example, when the user makes a designation on a page of the material being displayed by using a mouse (mouse click, pointer movement, or the like), the controller 11 receives the operation corresponding to the designation. When receiving the operation (S25: Yes), the controller 11 transitions the processing to step S26. On the other hand, when the operation is not received (S25: No), the controller 11 transitions the processing to step S27.

### Step S26

In step S26, the controller 11 stores information of a page being displayed. Specifically, the controller 11 acquires identification information of the material being displayed (material ID), identification information of the page being displayed (such as the page number or the slide number), position information of the pointer (such as coordinates or movement trajectory), and time information (such as time of designation by and movement of the pointer), and stores the information as the meeting material information D5 in the storage 12 (see FIG. 13).

### Step S27

In step S27, the controller 11 determines whether an operation of ending the meeting has been received. For example, the user A ends the meeting application in a case of ending the meeting. In a case of having received the operation of ending the meeting application, the controller 11 determines that the meeting end operation has been received. Upon determining that the meeting end operation has been received (S27: Yes), the controller 11 ends the meeting assistance processing. On the other hand, in a case of not having received the meeting end operation (S27: No), the controller 11 returns the processing to step S22. The controller 11 repeatedly executes the processing in steps S23 to S26 described above each time the voice is acquired. Accordingly, each time the user utters a voice, the summary sentence corresponding to the voice and the operation information for the page of the material being displayed can be registered.

### Minutes Display Processing

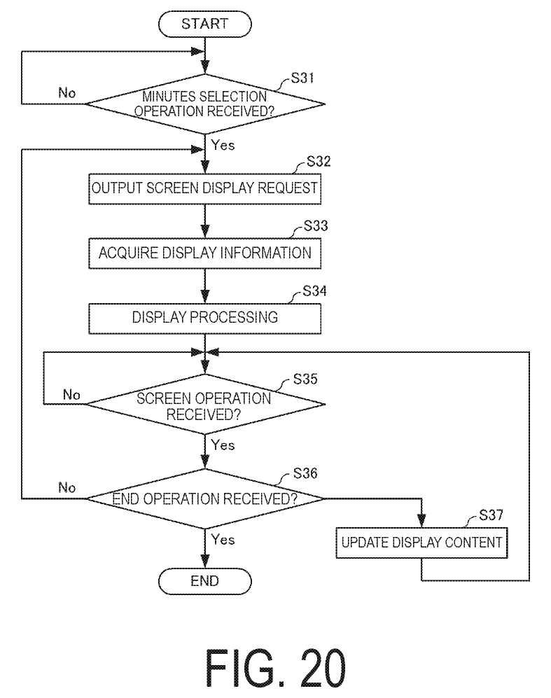

FIG. 20 illustrates an example of a procedure of minutes display processing. The minutes display processing is included in the meeting assistance processing (see FIG. 11). It is noted that, while an example in which the user terminal 3 (controller 31) executes the minutes display processing will be described below, the meeting assistance device 1 (the controller 11) may execute the minutes display processing as another embodiment. For example, the controller 11 may output a command to display the minutes to the user terminal 3, and the user terminal 3 may execute browser processing for displaying an image according to the command.

### Step S31

In step S31, the controller 31 determines whether an operation of selecting meeting minutes has been received by the user terminal 3. For example, the user who is a participant of the meeting activates the meeting application on the user terminal 3 and selects a meeting which the user wishes to view on the minutes list screen P10 (see FIG. 14). Upon receiving the meeting selection operation from the user (S31: Yes), the controller 31 transitions the processing to step S32. The controller 31 stands by while no selection operation is received from the user (S31: No).

### Step S32

Next, in step S32, the controller 31 outputs a request (screen display request) for displaying the selected minutes on the user terminal 3 to the meeting assistance device 1.

### Step S33

Next, in step S33, the controller 31 acquires display information from the meeting assistance device 1. Specifically, the controller 31 acquires display information for the minutes screen P3 (see FIG. 15 and the like) constituting the minutes.

### Step S34

Next, in step S34, the controller 31 executes display processing of displaying the minutes screen P3 on the user terminal 3. As illustrated in FIG. 15 for example, the controller 31 causes a summary sentence to be displayed in the summary display area P31 of the minutes screen P3, and causes the corresponding page of the material to be displayed in the material display area P32 of the minutes screen P3. For example, the controller 31 causes the first page of the material displayed on the display device 5 immediately after the start of the meeting to be displayed in the material display area P32, and causes the summary sentence of the conversation of discussion made while the first page is displayed, to be displayed in the summary display area P31.

As another embodiment, the page displayed first in the material display area P32 of the minutes screen P3 may be (1) a conclusion in a meeting summary, (2) a page including an action item, (3) a page including a summary sentence or a word marked by the user in summary sentences or conversations (see FIG. 10 and the like), (4) a sheet (an application displayed in a page unit or the like) or a portion (an application displayed by scrolling or the like) with the longest display time, (5) a page on which pen input, character input, or marking input is performed by a presenter, (6) a page for which a specific person has spoken, or the like.

A specific example of how (6) described above is displayed will be described below. For example, the controller 31 causes icons (user icons) of utterers who have spoken in the meeting for an agenda to be displayed in association with each agenda in the minutes list screen P10 (see FIG. 14) in a selectable manner, and when the user selects a desired user icon and presses an "open" button, the controller 31 causes a page (first page) (page associated with the summary sentence for the utterer) corresponding to the utterance of the utterer of the selected user icon to be displayed. In this manner, the controller 31 may cause the material icon F1 and the user icon in a selectable manner to be displayed in association with each meeting, and cause a page corresponding to the icon (the material icon F1 or the user icon) selected by the user to be displayed in the material display area P32 of the minutes screen P3.

In addition, as another embodiment, in the case of a specific person, the controller 31 may cause a summary sentence corresponding to the utterance of the person to be identifiably displayed. In addition, in a case where the page of the material is turned, the controller 31 may preferentially cause only the page corresponding to the utterance of the person to be displayed.

### Step S35

Next, in step S35, the controller 31 determines whether the user terminal 3 has received a screen operation from the user. For example, the user can perform an operation of pressing each of the operation buttons K31 to K37 (see FIG. 15 and the like), an operation of ending the meeting, and the like on the minutes screen P3. Upon receiving the screen operation from the user (S35: Yes), the controller 31 transitions the processing to step S36. The controller 31 maintains the display screen until a screen operation is received from the user (S35: No).

### Step S36

In step S36, the controller 31 determines whether an operation to end the minutes display processing (display end operation) has been received. Upon receiving the end operation (S36: Yes), the controller 11 ends the minutes display processing. On the other hand, when the end operation is not received (S36: No), the controller 31 transitions the processing to step S37.

### Step S37

In step S37, the controller 31 updates the display content of the minutes screen P3 to the content corresponding to the screen operation. For example, when the user selects the summary sentence of "Summary 2" (see FIG. 15), the controller 31 causes the identification image Ma ("1") to be displayed in "Summary 2" of the summary display area P31, causes the movement range image Mc indicating the movement range of the pointer to be displayed in the page of the material display area P32, and causes the identification image Mb ("1") that is the same as the identification image Ma to be displayed in association with the movement range image Mc.

For example, when the user selects the summary sentence of "Summary 4" (see FIG. 17), the controller 31 causes a page ("Slide 4") corresponding to "Summary 4" to be displayed in the material display area P32.

Further, for example, when the user presses the "page summary" button K33 of the minutes screen P3, the controller 31 causes the page summary and the information on the page summary ("page summary statistics") to be displayed in the summary display area P31 as illustrated in FIG. 18.

After step S37, the controller 31 returns the processing to step S35. The controller 31 executes the above-described processing until the display end operation is received from the user.

As described above, the meeting assistance device 1 is a system that manages meeting information, and executes: acquiring a voice uttered by a user in a meeting; converting the acquired voice into text information; generating a summary of an utterance content of the user based on the converted text information; and causing the generated summary sentence and a page corresponding to the summary sentence among materials used in the meeting to be displayed side by side on a display screen.

According to the above configuration, since the material used in the meeting and the summary sentence of the content discussed while the material is being displayed during the meeting are displayed together on the minutes screen P3 displaying the minutes of the meeting, the user can recognize the content of the discussion corresponding to the material used in the meeting. Further, the user can understand the contents of the meeting by checking the minutes screen P3 without accessing the file of the material of the meeting.

The embodiment for managing the meeting material is not limited to the above-described embodiment. As another embodiment, when a word used in the summary is the same as a word existing in a page of the material, the meeting assistance device 1 may perform the displaying to enable the user to recognize such a portion. For example, the meeting assistance device 1 may cause the portion to be displayed in a font (red characters, underlines, or the like) different from that of the other portion.

As another embodiment, when the words or the contents of sentences in the page of the material are significantly different from the contents of the summary, the meeting assistance device 1 may cause the summary to be displayed so that the user can recognize such a portion.

As another embodiment, the meeting assistance device 1 may be capable of switching between a display mode under which the summary display area P31 and the material display area P32 are displayed side by side and a display mode under which only one of the summary display area P31 and the material display area P32 is displayed on the minutes screen P3 in accordance with a user operation.

As another embodiment, the meeting assistance device 1 may be capable of switching between the material display area P32 and the conversation display area P22 (see FIG. 8 and the like) in the minutes screen P3 in accordance with a user operation.

As another embodiment, the meeting assistance device 1 may cause the identification images Ma and Mb to be displayed at an important portion (for example, an important keyword registered in advance) of the summary sentence and a portion corresponding to the summary sentence of the page of the material.

In each of the above-described embodiments, the page (sheet) corresponding to the summary sentence displayed side by side with the summary sentence on the minutes screen P3 is an example of the specific part of the disclosure. For example, in a case where the material includes a plurality of pages, when the user designates a specific page displayed during the meeting, the meeting assistance device 1 registers the page in association with the summary sentence (refer to FIG. 13), and causes the summary sentence and the page to be displayed side by side on the minutes screen P3. The specific part of the disclosure is not limited to a page (sheet) of the material, and may be a part of the material. For example, when a part of the scrollable material (for example, a part from the X1th line to the X2th line, a specific figure, or the like) is displayed during the meeting, and the user designates the part, the meeting assistance device 1 registers the part in association with the summary sentence (see FIG. 13), and causes the summary sentence and the part to be displayed side by side on the minutes screen P3. The specific part of the disclosure may be a part of a specific page or part, displayed in an enlarged or reduced manner.

In the example described in each embodiment described above, the meeting room R1 and the meeting room R2 are connected through the network for the online meeting. However, the meeting assistance system 100 of the disclosure may be configured with only one meeting room R1. In this case, for example, in the meeting room R1, the meeting assistance device 1 executes transcription processing for causing the display device 5 to display text information obtained by converting the voice input to the microphone of the audio device 2. One audio device 2 (for example, a stationary microphone speaker device) may be installed in the meeting room R1, and the meeting assistance device 1 may convert voices of one or more users input to the microphone of the audio device 2 into text information. That is, in a case where the meeting assistance system 100 includes a transcription function, a plurality of audio devices 2 may be arranged for each user, or one audio device 2 may be arranged for a meeting room or a plurality of users.

In another embodiment, the speech recognition processing may include a translation function of converting a voice in a first language (for example, Japanese) into text in a second language (for example, English). For example, the controller 11 may translate each of the text information and the summary sentence and display the resultant text information and summary sentence, or may display the text information in the language of the conversation in the conversation display area P22 without translating the text information, and translate only the summary sentence and display the resultant summary sentence in the summary display area P21. By translating only the summary sentence, the time and cost required for translation can be reduced. The controller 11 may display, on the meeting screen P2, a translation button enabling the translation function to be switched on/off.

Note that the controller 11 of the meeting assistance device 1 controls the entire meeting assistance device 1. The controller 11 realizes various functions by reading and executing various programs stored in the storage 12 (for example, storage or ROM). The controller 11 may be implemented by one or more control devices/arithmetic devices (such as a central processing unit (CPU), and a system on a chip (SoC)). In addition, the controller 11 may include one or more control circuits (electronic circuits).

### Supplements of Disclosure

Hereinafter, an outline of the disclosure extracted from the above-described embodiments will be described as supplements. Configurations and processing functions described in the following supplements can be selected and combined as desired.

### Supplement 1

An information processing system for managing meeting information, the information processing system comprising:
an acquisition processing circuit that acquires a voice uttered by a user in a meeting;
a conversion processing circuit that converts the voice acquired by the acquisition processing circuit into text information;
a generation processing circuit that generates a summary of an utterance content of the user based on the text information obtained by the conversion by the conversion processing circuit; and
a display processing circuit that causes the summary generated by the generation processing circuit and a specific part of a material used in the meeting, corresponding to the summary to be displayed side by side on a display screen.

### Supplement 2

The information processing system according to Supplement 1, wherein the display processing circuit causes identification information to be displayed, the identification information being for enabling identification of a portion, in the specific part displayed on the display screen, corresponding to the summary.

### Supplement 3

The information processing system according to Supplement 2, wherein the display processing circuit causes a plurality of the summaries to be displayed in a first area of the display screen, and when the user selects a first summary from among the plurality of the summaries, cause the first summary and a portion corresponding to the first summary in the specific part to be identifiably displayed.

### Supplement 4

The information processing system according to Supplement 3, wherein the display processing circuit causes an identical identification image to be displayed in association with each of the first summary and the portion.

### Supplement 5

The information processing system according to any of Supplements 2 to 4, wherein the display processing circuit causes the identification image to be displayed in the portion, in the specific part, designated by the user in the meeting.

### Supplement 6

The information processing system according to any of Supplements 1 to 5, wherein when a plurality of the summaries displayed on the display screen include a second summary corresponding to a second specific part different from a first specific part displayed on the display screen, and the user selects the second summary, the display processing circuit causes the second specific part to be displayed on the display screen.

### Supplement 7

The information processing system according to any of Supplements 1 to 6, wherein when a plurality of the summaries displayed on the display screen include a first summary corresponding to a first specific part being displayed on the display screen and a second summary corresponding to a second specific part different from the first specific part, the display processing circuit causes the first summary and the second summary to be displayed on the display screen in different display modes.

### Supplement 8

The information processing system according to any of Supplements 1 to 7, wherein when a predetermined display request is received from the user, the display processing circuit causes a specific summary generated based on a plurality of the summaries corresponding to the specific part displayed on the display screen to be displayed.

### Supplement 9

The information processing system according to any of Supplements 1 to 8, wherein the display processing circuit causes, together with the specific summary, a total time for which the specific part is displayed during the meeting, the number of times of transition from a page of the specific part to another page during the meeting, and identification information of a user who has issued an utterance while the specific part is displayed during the meeting to be displayed.

### Supplement 10

An information processing method for managing meeting information, the information processing method including:
by one or more processors,
acquiring a voice uttered by a user in a meeting;
converting the voice into text information;
generating a summary of an utterance content of the user based on the text information; and
causing the summary and a specific part, in a material used in the meeting, corresponding to the summary to be displayed side by side on a display screen.

### Supplement 11

A non-transitory computer-readable recording medium recording an information processing program,
the information processing program causing one or more processors to execute:
   acquiring a voice uttered by a user in a meeting;
   converting the voice into text information;
   generating a summary of an utterance content of the user based on the text information; and
   causing the summary and a specific part, in a material used in the meeting, corresponding to the summary to be displayed side by side on a display screen.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing system for managing meeting information, the information processing system comprising:
one or more processors, wherein
the one or more processors
acquire a voice uttered by a user in a meeting,
convert the voice into text information,
generate a summary of an utterance content of the user based on the text information, and cause the summary and a specific part of a material used in the meeting, corresponding to the summary to be displayed side by side on a display screen.

2. The information processing system according to claim 1, wherein the one or more processors cause identification information to be displayed, the identification information being for enabling identification of a portion, in the specific part displayed on the display screen, corresponding to the summary.

3. The information processing system according to claim 2, wherein the one or more processors cause a plurality of the summaries to be displayed in a first area of the display screen, and when the user selects a first summary from among the plurality of the summaries, cause the first summary and a portion corresponding to the first summary in the specific part to be identifiably displayed.

4. The information processing system according to claim 3, wherein the one or more processors cause an identical identification image to be displayed in association with each of the first summary and the portion.

5. The information processing system according to claim 2, wherein the one or more processors cause the identification information to be displayed in the portion, in the specific part, designated by the user in the meeting.

6. The information processing system according to claim 1, wherein when a plurality of the summaries displayed on the display screen include a second summary corresponding to a second specific part different from a first specific part displayed on the display screen, and the user selects the second summary, the one or more processors cause the second specific part to be displayed on the display screen.

7. The information processing system according to claim 1, wherein when a plurality of the summaries displayed on the display screen include a first summary corresponding to a first specific part being displayed on the display screen and a second summary corresponding to a second specific part different from the first specific part, the one or more processors cause the first summary and the second summary to be displayed on the display screen in different display modes.

8. The information processing system according to claim 1, wherein when a predetermined display request is received from the user, the one or more processors cause a specific summary generated based on a plurality of the summaries corresponding to the specific part displayed on the display screen to be displayed.

9. The information processing system according to claim 8, wherein the one or more processors cause, together with the specific summary, a total time for which the specific part is displayed during the meeting, the number of times of transition from a page of the specific part to another page during the meeting, and identification information of a user who has issued an utterance while the specific part is displayed during the meeting to be displayed.

10. An information processing method, executed by one or more processors, for managing meeting information, the information processing method comprising:
acquiring a voice uttered by a user in a meeting;
converting the voice into text information;
generating a summary of an utterance content of the user based on the text information; and
causing the summary and a specific part, in a material used in the meeting, corresponding to the summary to be displayed side by side on a display screen.

11. A non-transitory computer-readable recording medium recording an information processing program for managing meeting information, the information processing program causing one or more processors to execute:
acquiring a voice uttered by a user in a meeting;
converting the voice into text information;
generating a summary of an utterance content of the user based on the text information; and
causing the summary and a specific part, in a material used in the meeting, corresponding to the summary to be displayed side by side on a display screen.
